(19) United States
(12) Patent Application Publication
(10) Pub. No.: US 2012/0051574 A1
(43) Pub. Date: Mar. 1, 2012

(54) IN-EAR HEADPHONE

(75) Inventor: You-Ruei Lin, Taipei (TW)

(73) Assignee: CHENG UEI PRECISION INDUSTRY CO., LTD., Taipei (TW)

(21) Appl. No.: 12/872,047

(22) Filed: Aug. 31, 2010

(51) Int. Cl. H04R 1/20

(52) U.S. Cl. 381/353; 381/380

(57) ABSTRACT

An in-ear headphone has a shell, a loudspeaker accommodated in a space of the shell for making sound, an ear cushion fixed on a supporting portion of the shell. A through channel passes the whole supporting portion for connecting the space with outside to transmit the sound produced by the loudspeaker. The ear cushion has a through hole passing through the whole ear cushion. A top of the through hole is enlarged to form a first receiving cavity for receiving a first damper. The first damper can seal against the outside region preventing the particles into the in-ear headphone and damaging the loudspeaker. Also, the first damper adjusts the sound effect of the in-ear headphone. Moreover, the first damper can be taken off the first receiving cavity easily and replaced by another one. So, the user can experience varies sound effect by changing the first damper.

### BACKGROUND OF THE INVENTION

1. Field of the Invention

The present invention relates to a headphone, and more particularly to an in-ear headphone capable of adjusting the sound effect according to user's preference.

2. The Related Art

A headphone connected with a music player can help the user to enjoy music and not affect others. FIGS. 5-6 show a conventional in-ear headphone 1′. The in-ear headphone 1′ includes a shell 10′, a loudspeaker 11′ accommodated in a space 12′ of the shell 10′, an ear cushion 20′ fixed on a protruding portion 13′ protruded from a top of the shell 10′. The protruding portion 13′ has a through channel 14′ penetrating a top and a bottom thereof to communicate with the space 12′ and outside. A top of the through channel 14′ is enlarged to form a receiving cavity 15′ for accommodating a damper 16′. The damper 16′ performs two functions, the first of which is to provide a seal against the outside region so as to prevent the particles into the in-ear headphone 1′ and damaging the loudspeaker 11′, the second of which is to adjust the sound effect of the in-ear headphone 1′ by means of lowering the high-frequency audio signal. However, as the damper 16′ is placed on the protruding portion 13′ and there is an ear cushion 20′ enclosing the protruding portion 13′, users can not change the damper 16′ and choose the sound effect according to their own preference.

### SUMMARY OF THE INVENTION

Accordingly, an object of the present invention is to provide an in-ear headphone. The in-ear headphone includes a shell, a loudspeaker accommodated in a space of the shell for making sound, an ear cushion fixed on shell. The shell has a supporting portion protruded form a top of the shell. A through channel passes through the whole supporting portion for connecting the space with outside to transmit the sound produced by the loudspeaker. The ear cushion fixed on the supporting portion of the shell has a through hole passing through the whole ear cushion for accommodating the supporting portion. A top of the through hole is enlarged to form a first receiving cavity for receiving a first damper.

As described above, the top of the through hole is enlarged to form a first receiving cavity for accommodating the first damper. On one hand, the first damper seals against the outside region preventing the particles into the in-ear headphone and damaging the loudspeaker. On the other hand, the first damper adjusts the sound effect of the in-ear headphone by means of lowering the high-frequency audio signal. Moreover, the first damper can be taken off the first receiving cavity easily and replaced by another one. So, the user can experience varies sound effect by changing the first damper.

### BRIEF DESCRIPTION OF THE DRAWINGS

The present invention will be apparent to those skilled in the art by reading the following description thereof, with reference to the attached drawings, in which:

FIG. 1 is an assembled, cross-sectional view of an in-ear headphone of a first embodiment according to the present invention;

FIG. 2 is an exploded, cross-sectional view of the in-ear headphone shown in FIG. 1;

FIG. 3 is an assembled, cross-sectional view of an in-ear headphone of a second embodiment according to the present invention;

FIG. 4 is an exploded, cross-sectional view of the in-ear headphone shown in FIG. 3;

FIG. 5 is an assembled, cross-sectional view of a conventional in-ear headphone; and

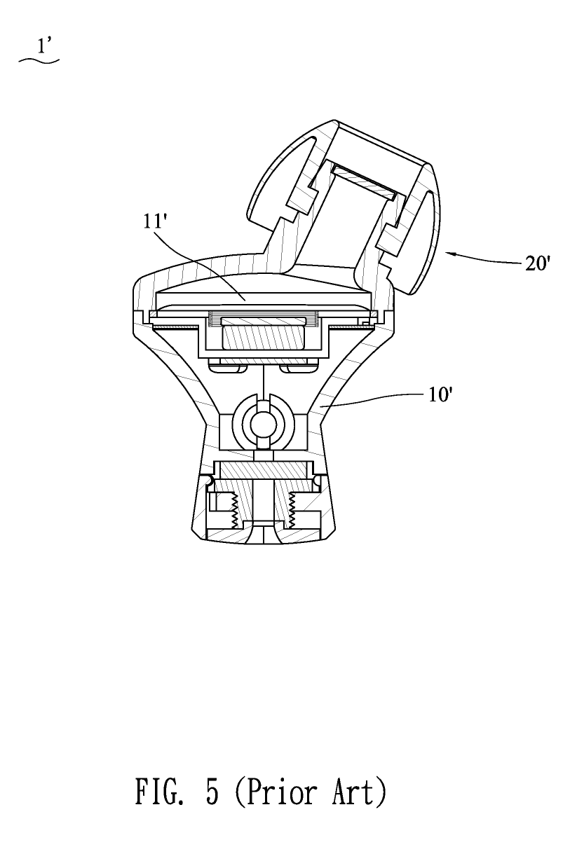

FIG. 6 is an exploded, cross-sectional view of the conventional in-ear headphone shown in FIG. 5.

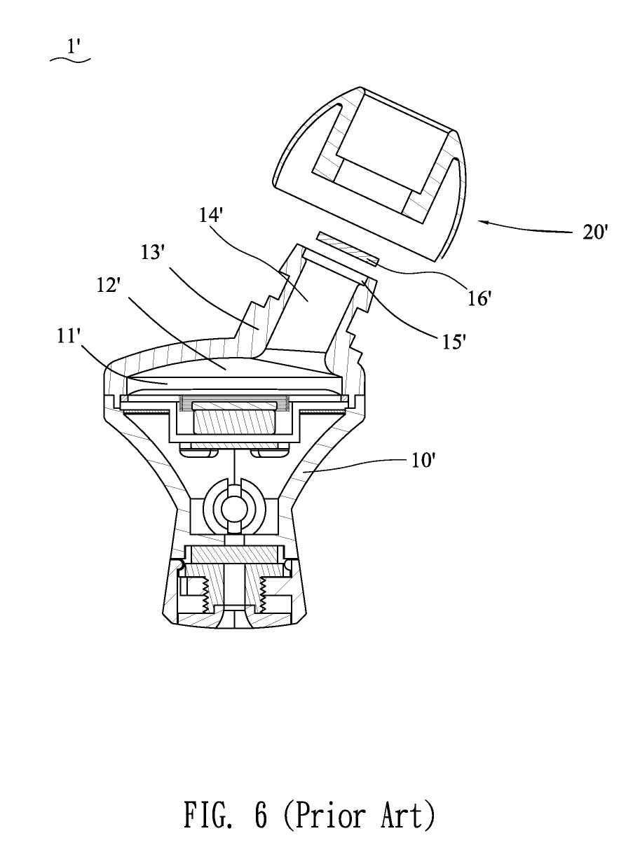

### DETAILED DESCRIPTION OF THE EMBODIMENT

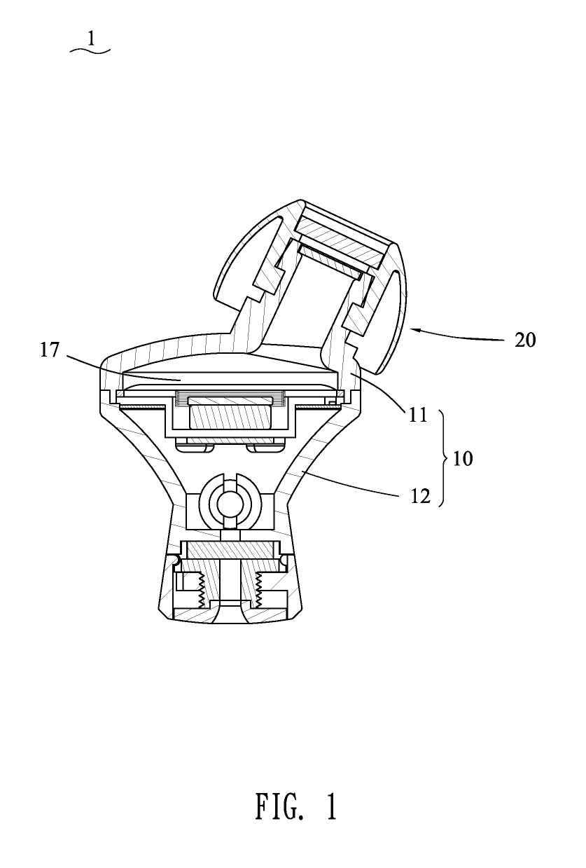

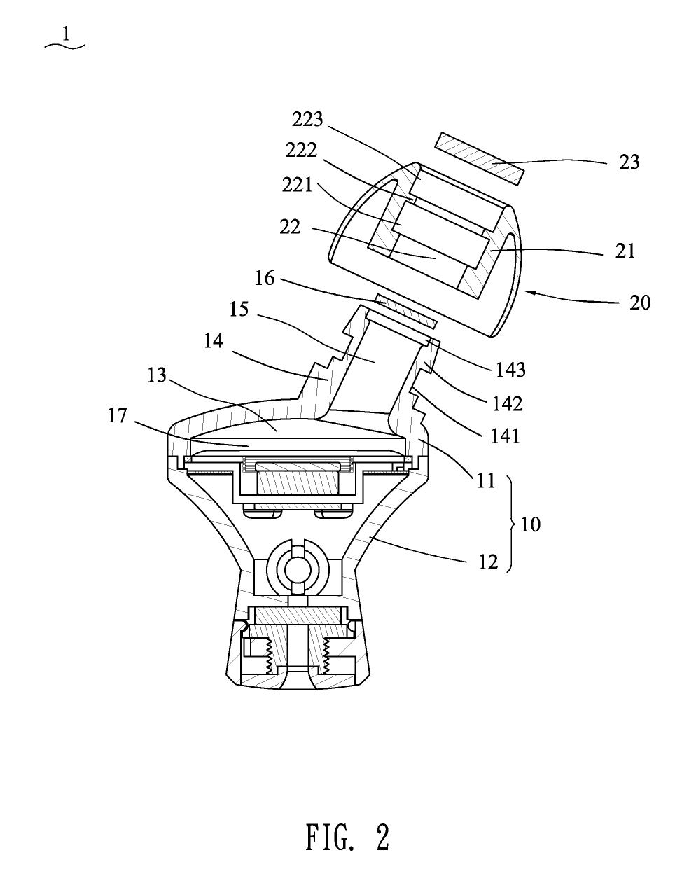

Referring to the drawings in greater detail, and first to FIGS. 1-2, the embodiment of the invention is embodied in an in-ear headphone 1. The in-ear headphone 1 includes a shell 10, a loudspeaker 17 accommodated in the shell 10, an ear cushion 20 fixed on the shell 10.

Please refer to FIGS. 1-2, the ear cushion 20 has a round base 21. The base 21 has a through hole 22 formed at a middle of the base 21 and penetrating through a top and a bottom thereof. A top of the through hole 22 is enlarged to form a first receiving cavity 223 for receiving a first damper 23 of round plate shape. A middle of the through hole 22 is enlarged to form a buckling recess 221. A ring-shaped blocking plate 222 is formed between the first receiving cavity 223 and the buckling recess 221.

The shell 10 has an upper shell 11 and a lower shell 12. The upper shell 11 cooperates with the lower shell 12 to form a space 13 for receiving the loudspeaker 17. A supporting portion 14 of column shape is protruded upward and slanted outwards from a top of the upper shell 11. A through channel 15 is formed at a middle of the supporting portion 14 and passes through the whole supporting portion 14 with a bottom thereof communicating with the space 13 and a top thereof communicating with outside. The top of the through channel 15 is enlarged to form a second receiving cavity 143 for receiving a second damper 16. A middle portion of an outer surface of the supporting portion 14 is recessed to form a circle recess 141, and correspondingly, a buckling portion 142 is formed at an upper portion of the supporting portion 14.

In assembly, the loudspeaker 17 is placed in the space 13. The second damper 16 is placed on the second receiving cavity 143. As the through channel 15 communicates with the space 13, the sound produced by the loudspeaker 17 passes through the through channel 15. The second damper 16 can lower the high-frequency audio signal. So, the sound effect is better. The ear cushion 20 is fixed on the supporting portion 14 by the buckling portion 142 buckling with the buckling recess 221. The first damper 23 placed in the first receiving cavity 223 has the same function as the second damper 16. The difference between the first damper 23 and the second damper 16 is that the first damper 23 can be taken off the first receiving cavity 223 easily and replaced by another one.

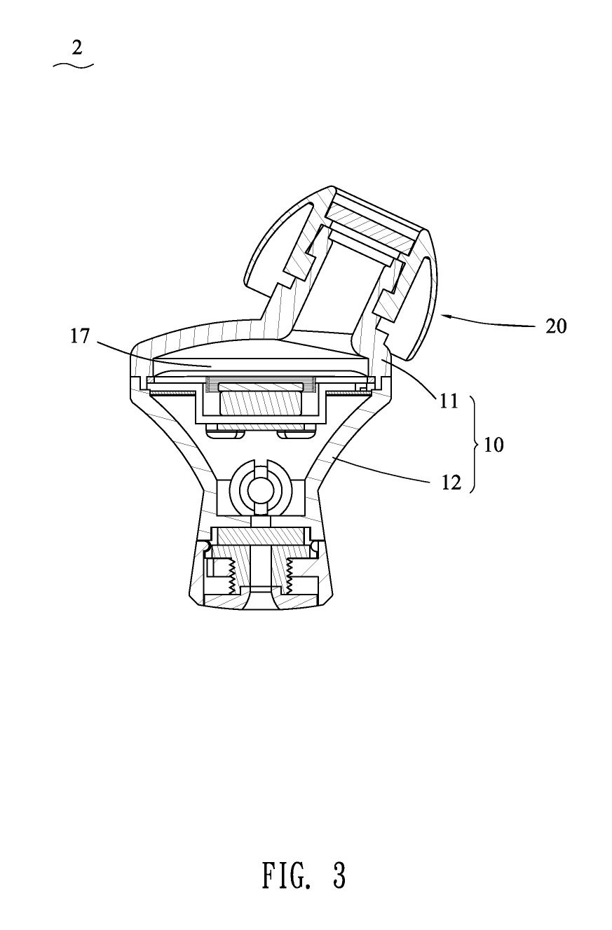

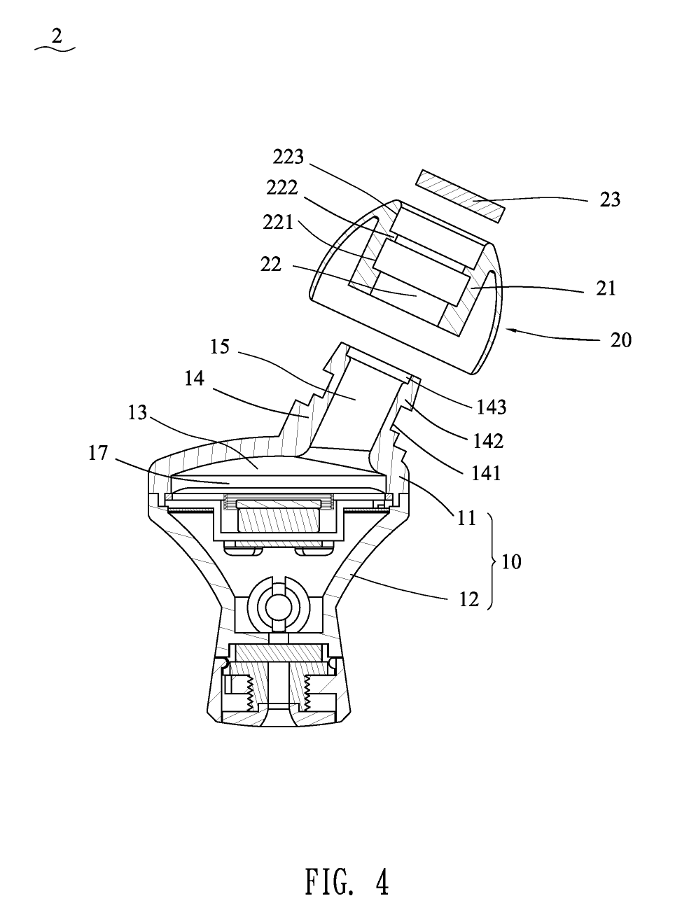

Please refer to FIGS. 3-4, an in-ear headphone 2 of a second embodiment according to the present invention is illustrated. In comparison with the first embodiment, the structure of the in-ear headphone 2 according to the second embodiment is same as that of the in-ear headphone 1 according to the first embodiment except that there is no second damper 16.

As described above, the top of the through hole 22 is enlarged to form a first receiving cavity 223 for accommodating the first damper 23. On one hand, the first damper 23 provides a seal against the outside region to prevent the particles into the in-ear headphone 1 and damaging the loudspeaker 17. On the other hand, the first damper 23 adjusts the sound effect of the in-ear headphone 1 by means of lowering the high-frequency audio signal. Moreover, the first damper 23 can be taken off the first receiving cavity 223 easily and replaced by another one. So, the user can experience varies sound effect by changing the first damper 23.

What is claimed is:

1. An in-ear headphone, comprising:
a loudspeaker for making sound;
a shell having a space for accommodating the loudspeaker, a supporting portion protruded from a top of the shell, a through channel passing through the whole supporting portion for connecting the space with outside to transmit the sound produced by the loudspeaker; and
an ear cushion fixed on the supporting portion of the shell having a through hole passing through the whole ear cushion for accommodating the supporting portion, a top of the through hole enlarged to form a first receiving cavity for receiving a first damper.

2. The in-ear headphone as claimed in claim 1, wherein a top of the through channel is enlarged to form a second receiving cavity for receiving a second damper to adjust the sound.

3. The in-ear headphone as claimed in claim 1, wherein a middle portion of an outer surface of the supporting portion is recessed to form a circle recess, and correspondingly, a buckling portion is formed at an upper portion of the supporting portion, the buckling portion is mated with a buckling recess formed at a middle of the through hole for fixing the ear cushion on the supporting portion.
